(19) United States
(12) Patent Application Publication
(10) Pub. No.: US 2012/0285875 A1
(43) Pub. Date: Nov. 15, 2012

(54) METHOD AND APPARATUS FOR TEMPERATURE CONDITIONING AN EXTRACTOR

(76) Inventor: George E. Anderson, Champlin, MN (US)

(21) Appl. No.: 13/470,420

(22) Filed: May 14, 2012

Related U.S. Application Data
(60) Provisional application No. 61/485,989, filed on May 13, 2011.

(51) Int. Cl. B01D 33/60

(52) U.S. Cl. 210/216

(57) ABSTRACT

A desolventizing process equipment. It employs a cold solvent washing station inserted in line with hot miscella washing stations. The equipment thereby affords temperature control of a miscella and material processed by the equipment.

### CROSS-REFERENCE TO RELATED APPLICATIONS

This is a regular application filed under 35 U.S.C. §111(a) claiming priority, under 35 U.S.C. §119(e)(1), of provisional application Ser. No. 61/485,989, previously filed May 13, 2011, under 35 U.S.C. §111(b).

### TECHNICAL FIELD

The present invention deals broadly with systems and processes involving temperature conditioning of an extractor equipment. Such a machine forms a miscella when an agricultural product is treated with a solvent, such as hexane, during processing. More specifically, however, the invention is directed to such a system and apparatus for preventing undesired vaporization of hexane, a consequence of which is that gravity drainage of the solution through the material being processed occurs at a reduced rate.

### BACKGROUND OF THE INVENTION

In agricultural product processing systems, a solvent is often used to wash the agricultural product which typically takes the form of flake material. While any number of solvents can be used in such systems, hexane is a typical agent. In a state of the art extraction process, hexane is washed over the flake material and, when hexane as a solvent is so utilized, an oily solution is formed. Such a solution is known as “miscella”.

The solvent treatment is typically performed in a counter-flow fashion. In the process as discussed hereinbefore, previously untreated flake material interacts with the solution of the lowest oil content at the inlet of the extractor, and the solution with the highest oil contact interacts with the flake material near the outlet of the extractor.

What can occur as a consequence is a situation wherein a very warmed flake material entering the extractor causes problems. When recycled miscella engages a surface that is very hot, the temperature of the oil/solvent solution increases. Consequently, some of the hexane can begin to vaporize. Such a formation of hexane vapor reduces the pressure of the solution in a porous material matrix. This results in a reduction in the rate at which gravity drainage through the flaked material near an outlet end of the machine occurs.

It is to these problems and shortcomings of the prior art that the present invention is directed. It is a method and apparatus for recovering hexane having been used in an agricultural product treatment process. The present process is safe, economical and technically viable.

### SUMMARY OF THE INVENTION

The present invention is a method and apparatus for temperature conditioning of an extractor when a solvent, such as hexane, is separated from miscella formed when a product of an agricultural commodity is treated. The inventive apparatus employs a structure having an inlet through which flaked material is introduced into the apparatus. The flaked material is deposited on a screen over which a conveyor to move the material in a direction along the screen passes. Typically, a multiplicity of chain flights are provided for this purpose. The chain flights are, it is intended, spaced at substantially equal distances along the conveyor means.

The flaked solids are introduced in a warm condition. They are introduced through an inlet, deposited on the screen and moved by the chain flight mechanism. As they are so moved, they are subjected to a first wash. The first wash is accomplished by means of a plurality of nozzles through which the miscella is introduced into a washing chamber. Typically, the plurality of nozzles are spaced from adjacent nozzles at sequentially similar distances. The miscella passing through the nozzles is maintained at a desired temperature.

In the present invention, interposed between the solid material inlet and the first wash nozzles is one or more cold solvent injectors. The injector is located to deposit a “cold” solvent into the flaked material as it passes over the screen. The solvent is maintained in a “cold” condition. “Cold” is defined as at least 5° below boiling point. It will be understood, however, that the greater the temperature differential beneath the boiling point and the temperature of the miscella, the more efficiently the apparatus will function.

A valve can be positioned in an interconnecting line between the cold solvent feed and the first wash feed. If the valve is opened to allow passage of fluid therethrough, the “cold” solvent will be mixed with hot miscella from the standard or typical wash system. Consequently, the reduced temperature mixture in the area of the first wash will have the effect of the cool solvent alone. It will be understood that the present invention is considered to include any system which provides a mixture of cool and hot miscella to the first wash.

The present invention is thus an improved apparatus and process for removing a solvent from flaked material. As previously pointed out, the invention renders processing safe, economical and technically viable.

### BRIEF DESCRIPTION OF THE DRAWINGS

FIG. 1 is a perspective view of a portion of an apparatus in accordance with the present invention; and

FIG. 2 is a side elevational view of the structure illustrated in FIG. 1.

### DETAILED DESCRIPTION OF THE INVENTION

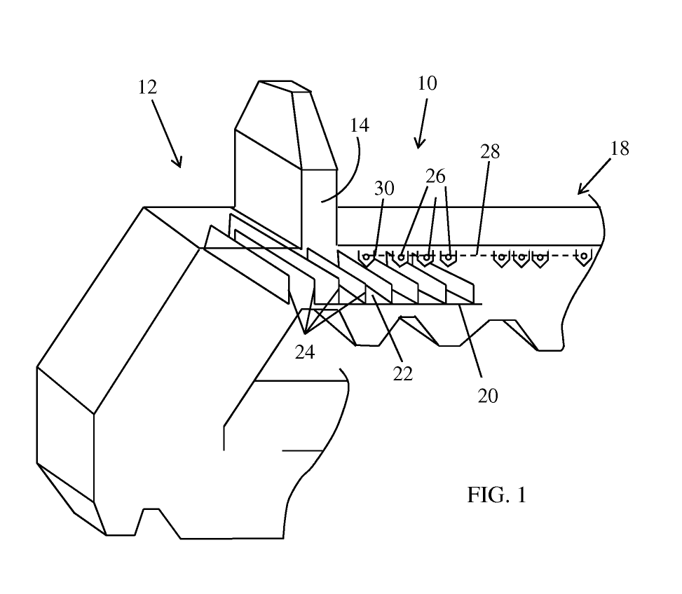

FIG. 1 generally illustrates an inlet end of an extractor 10 in accordance with the present invention. The inlet end 12 is defined by an inlet chute 14 through which an agricultural product can be introduced into the machine 10 for processing. It will be understood that the apparatus 10 illustrated in the drawings, while used heavily in the agricultural product processing industry, is anticipated to be able to be used for processing any flake or granular material in which a solvent has been entrained.

The material being processed is made to transit the machine 10 from the inlet 14 to a screen drainage station 16 proximate the outlet end 18 of the machine 10. Transition is accomplished by means of a conveyor 20 which, as viewed in the drawing figures, moves from left to right and moves the material being process from left to right. The figures illustrate a moving screen 22 having a multiplicity of chain flights 24 to effect the desired movement of the agricultural material.

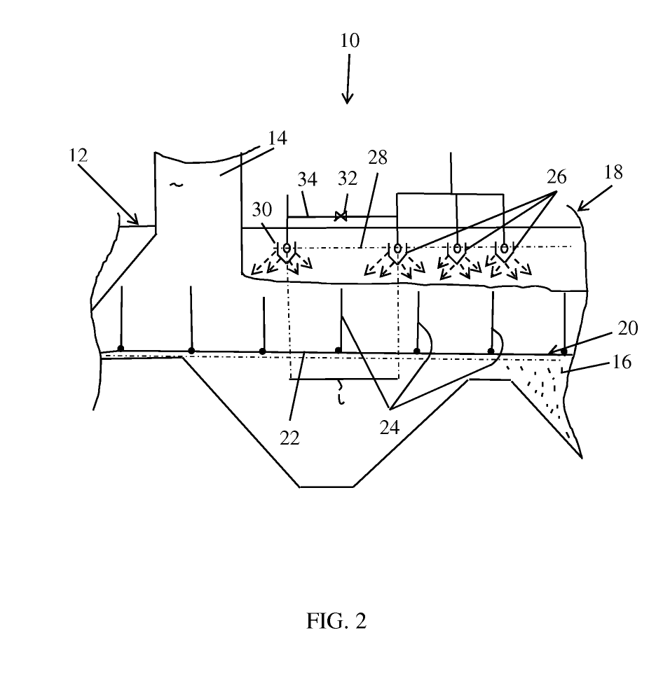

Prior art structures, and a structure in accordance with the present invention, employ at least one warm miscella washing station 26, spaced along an axis 28, generally parallel to the screen conveyor 20 direction of movement, from the inlet chute 14. FIG. 2 illustrates three of such hot miscella washing stations 26. They are spaced sequentially along said axis 28, and, although it is not a requirement, the spacing between any two adjacent of such stations is generally the same.

The invention contemplates the insertion of at least one cold solvent washing station 30. While the figures illustrate a single such station 30, it will be understood that multiple stations are contemplated as being within the scope of the invention.

The cold solvent station 30 illustrated, it will be noted, is spaced sequentially between the inlet chute 14 and the first hot miscella washing station 26. The agricultural material being processed will, thereby, be maintained at a safe temperature. It is contemplated that the distance between the cold solvent washing station 30 and the first hot miscella washing station 26 may be of any practical distance. This distance can vary from very small to many feet.

What is identified herein as “cold” is defined as being at last five degrees below the boiling point.

FIG. 2 illustrates a valve 32 which can be disposed in a line between the cold solvent washing station 30 and the first hot miscella washing station 26. When such a valve 32 is provided and is in an open configuration, the cool solvent will be mixed with hot miscella. Control of the temperature of the material can thereby be controlled.

It will be understood that this disclosure, in many respects, is only illustrative. Changes may be made in details, particularly in matters of shape, size, material, and arrangement of parts without exceeding the scope of the invention. Accordingly, the scope of the invention is as defined in the language of the appended claims.

What is claimed is:

1. A machine for desolventizing miscella having been used in a process for treating a flake or granular agricultural material, comprising:
(a) a screen conveyor for transporting the material from an inlet end of the machine to an outlet end thereof;
(b) an inlet through which the material is deposited on said screen conveyor at said inlet end thereof;
(c) a series of at least one warm miscella washing station spaced sequentially along an axis, generally parallel to said conveyor, from said inlet; and
(d) a cold solvent washing station disposed proximate said axis and intermediate said inlet and a first of said warm miscella washing stations.
